(19) United States
(12) Patent Application Publication
(10) Pub. No.: US 2024/0301571 A1
(43) Pub. Date: Sep. 12, 2024

(54) ELECTROCHEMICAL MODULE

(71) Applicant: HONDA MOTOR CO., LTD., TOKYO (JP)

(72) Inventors: Toru HONDA, WAKO-SHI (JP); Osamu YODA, HAGAGUN (JP)

(21) Appl. No.: 18/582,049

(22) Filed: Feb. 20, 2024

(30) Foreign Application Priority Data
Mar. 8, 2023 (JP) 2023-035126

(51) Int. Cl. C25B 9/77; C25B 1/04; C25B 9/23; C25B 9/67; F04B 43/04

(52) U.S. Cl. CPC C25B 9/77; C25B 9/23; C25B 9/67; F04B 43/04; C25B 1/04

(57) ABSTRACT

The electrochemical module is formed by stacking a plurality of membrane electrode assemblies having electrolyte membranes, anodes and cathodes. The plurality of membrane electrode assemblies are stacked so that a first region where the anodes face each other and a second region where the cathodes face each other appear alternately in the stacking direction. Further, at least one of the first region and the second region includes a common flow path shared by two adjacent membrane electrode assemblies.

### CROSS-REFERENCE TO RELATED APPLICATIONS

This application is based upon and claims the benefit of priority from Japanese Patent Application No. 2023-035126 filed on Mar. 8, 2023, the contents of which are incorporated herein by reference.

### BACKGROUND OF THE INVENTION

### Field of the Invention

The present invention relates to an electrochemical module in which a plurality of electrolyte membranes are laminated.

### Description of the Related Art

In recent years, research and development have been conducted on electrochemical modules that contribute to energy efficiency in order to ensure that more people have access to affordable, reliable, sustainable and modern energy.

Examples of such an electrochemical module include a high differential pressure water electrolysis device and an electrochemical hydrogen compressor. Such an electrochemical module is formed by stacking a plurality of unit cells each including an electrolyte membrane (see, for example, JP 2016-089229 A). Each of the unit cells includes a membrane electrode assembly formed by sandwiching an electrolyte membrane between an anode and a cathode, flow paths each for supplying a fluid such as gas or water to each of the anode and the cathode, and a pair of separator plates forming the flow paths.

### SUMMARY OF THE INVENTION

To increase the output produced by the electrochemical reactions brought in the electrochemical module, it is necessary to increase the number of unit cells to be stacked. However, when the number of unit cells stacked is increased, the electrochemical module is increased in its size in the stacking direction of the unit cells.

An object of the present invention is to solve the aforementioned problem.

An aspect of the following disclosure is an electrochemical module including a plurality of membrane electrode assemblies stacked one another, the membrane electrode assemblies including electrolyte membranes, and anodes and cathodes sandwiching the electrolyte membranes, wherein the plurality of membrane electrode assemblies are stacked in a manner that a first region where the anodes face each other and a second region where the cathodes face each other appear alternately in a stacking direction, and at least one of the first region and the second region includes a common flow path shared by two adjacent membrane electrode assemblies.

The above-described electrochemical module can suppress an increase in its size in the stacking direction while increasing the output produced by the electrochemical reactions.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a hydrogen pump according to an embodiment;

FIG. 2 is an exploded perspective view of the hydrogen pump shown in FIG. 1; and

FIG. 3 is a cross-sectional view of the electrochemical module of the hydrogen pump shown in FIG. 1.

### DETAILED DESCRIPTION OF THE INVENTION

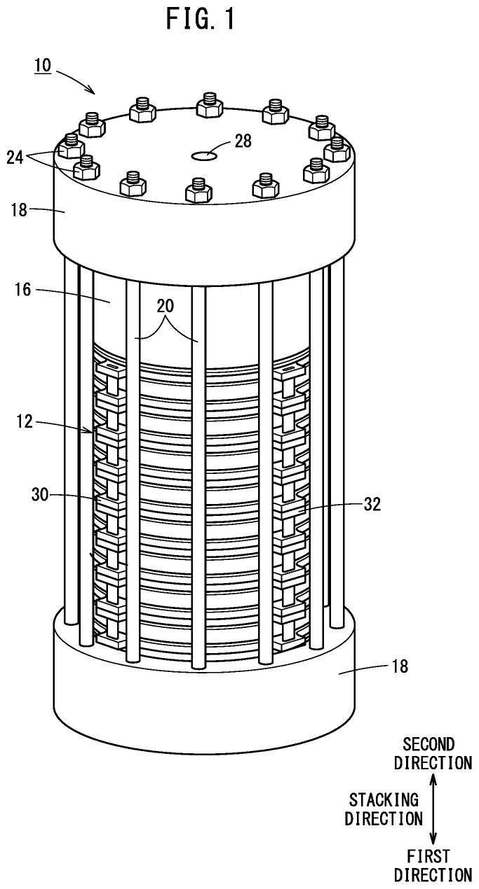

A hydrogen pump 10 according to the embodiment shown in FIG. 1 is an electrochemical hydrogen compressor that compresses hydrogen by electrochemical reactions. The hydrogen pump 10 is used in an energy storage system for compressing and storing hydrogen produced by excess electricity, a hydrogen station for supplying hydrogen to a moving object, or the like.

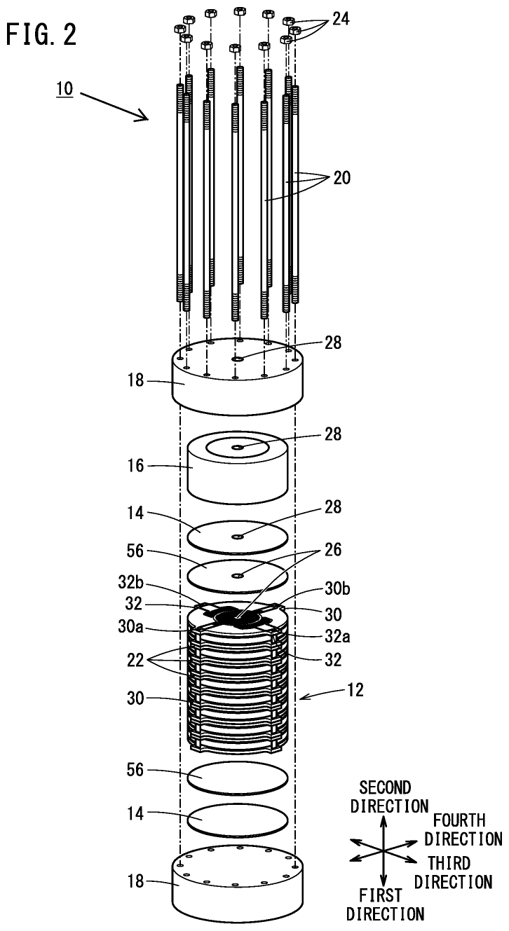

As shown in FIG. 2, the hydrogen pump 10 includes an electrochemical module 12, a pair of insulating plates 14, a cylinder unit 16, a pair of end plates 18, and stud bolts 20. The electrochemical module 12 is formed of a plurality of unit structures 22 stacked. Hereinafter, the direction in which the unit structures 22 of the electrochemical module 12 are stacked (the thickness-wise direction of the membrane electrode assembly 34) is referred to as the stacking direction. In the stacking direction, one direction (downward in FIG. 1) is referred to as a first direction, and the other direction opposite to the first direction is referred to as a second direction.

The electrochemical module 12 is sandwiched between the pair of insulating plates 14 and insulated from the end plates 18. The cylinder unit 16 is disposed between one of the end plates 18 and one of the insulating plates 14. The cylinder unit 16 incorporates an elastic member and applies a predetermined compressive force to the electrochemical module 12.

The pair of end plates 18 sandwich the electrochemical module 12 and the cylinder unit 16 in the stacking direction from the first direction and the second direction, and apply a predetermined fastening load to the electrochemical module 12. The fastening load applied by the end plates 18 is generated by attaching the plurality of stud bolts 20 to the pair of end plates 18 and tightening the stud bolts 20 with nuts 24.

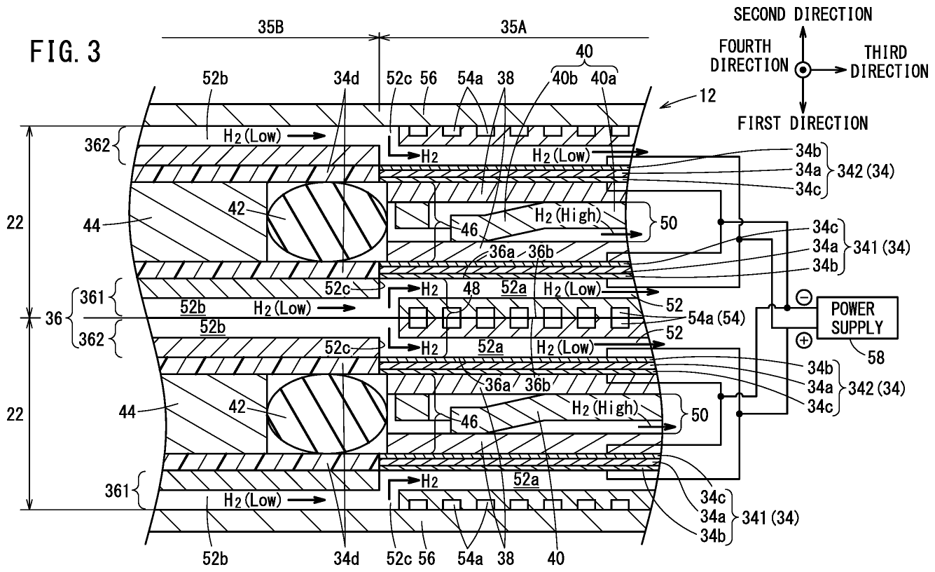

The electrochemical module 12 has a cylindrical shape. The electrochemical module 12 has a first passage 26 extending through its central portion in the stacking direction. The first passage 26 serves as a flow path for the hydrogen output from an electrolyte membrane 34a by the electrochemical reactions (see FIG. 3). The first passage 26 is in communication with a first passage 28 formed at the central portions of the insulating plates 14, the cylinder unit 16, and the end plates 18.

The electrochemical module 12 includes a pair of coolant supply and discharge units 30 for supplying a coolant to the side parts thereof and a pair of hydrogen supply and discharge units 32 for supplying low-pressure hydrogen gas. As shown in FIG. 2, the pair of coolant supply and discharge units 30 are 180° apart from each other in the circumferential direction. One of the coolant supply and discharge units 30 has a second passage 30a for supplying the coolant, and the other of the coolant supply and discharge units 30 has a third passage 30b for discharging the coolant. The pair of hydrogen supply and discharge units 32 are 180° apart from each other in the circumferential direction. The hydrogen supply and discharge units 32 are arranged at a position separated from the coolant supply and discharge units 30 by 90° in the circumferential direction. One of the hydrogen supply and discharge units 32 has a fourth passage 32a for supplying hydrogen, and the other of the hydrogen supply and discharge units 32 has a fifth passage 32b for discharging hydrogen. A direction connecting the pair of hydrogen supply and discharge units 32 is referred to as a third direction, and a direction connecting the pair of coolant supply and discharge units 30 is referred to as a fourth direction. The third direction and the fourth direction are orthogonal to each other.

The electrochemical module 12 is formed by stacking a plurality of unit structures 22. Hereinafter, the unit structure 22 is used as a term indicating a minimum unit of a structure repeated in the stacking direction. In the present embodiment, as described later, one unit structure 22 includes two layers of electrolyte membranes 34a. The number of unit structures 22 stacked in the electrochemical module 12 is not limited to the example shown in the drawings. The electrochemical module 12 that realizes the output suitable for practical use may include several to several hundred unit structures 22 stacked. The electrochemical module 12 and the unit structure 22 will be described in detail below.

In the electrochemical module 12 shown in FIG. 3, two unit structures 22 are stacked. Each of the unit structures 22 includes, as main components, a first membrane electrode assembly 341, a second membrane electrode assembly 342, a first support plate 361, a second support plate 362, a conductive plate 38, a spacer 40, a packing 42, and a pressure-resistant body 44. The first membrane electrode assembly 341 and the second membrane electrode assembly 342 are collectively referred to as a membrane electrode assembly 34.

The membrane electrode assembly 34 includes the electrolyte membrane 34a, an anode 34b, a cathode 34c, and a resin frame 34d. The electrolyte membrane 34a, the anode 34b and the cathode 34c are positioned in a reaction zone 35A where the electrochemical reactions occur, and the resin frame 34d is positioned in a periphery 35B surrounding the reaction zone 35A. The anode 34b generates H⁺ ions (protons) from the supplied hydrogen gas. Protons in the anode 34b are transported to the cathode 34c through the electrolyte membrane 34a. The cathode 34c generates hydrogen gas from the protons. The membrane electrode assembly 34 moves hydrogen gas from the anode 34b to the cathode 34c when a voltage is applied between the anode 34b and the cathode 34c.

The resin frame 34d is a circular, ring-shaped resin member that is joined to the electrolyte membrane 34a to support the electrolyte membrane 34a. The resin frame 34d is positioned in the periphery 35B of the membrane electrode assembly 34 to surround the electrolyte membrane 34a (reaction zone 35A). The resin frame 34d is in contact with the packing 42 and the pressure-resistant body 44 to seal the gap between the membrane electrode assemblies 34 for prevention of leakage of hydrogen gas.

As the membrane electrode assembly 34, the first membrane electrode assembly 341 is arranged such that the anode 34b faces the first direction and the cathode 34c faces the second direction. As the membrane electrode assembly 34, the second membrane electrode assembly 342 is arranged such that the anode 34b faces the second direction and the cathode 34c faces the first direction. In the electrochemical module 12, the first membrane electrode assembly 341 and the second membrane electrode assembly 342 are alternately arranged in the stacking direction.

The cathode 34c of the first membrane electrode assembly 341 and the cathode 34c of the second membrane electrode assembly 342 adjacent thereto in the second direction form a first region 46. The second region 48 is formed in the portion where two unit structures 22 are joined. That is, the second region 48 is formed between the first membrane electrode assembly 341 belonging to one unit structure 22 and the second membrane electrode assembly 342 belonging to the other unit structure 22. The first region 46 and the second region 48 appear alternately in the stacking direction.

The pair of conductive plates 38 and the spacer 40 are disposed in the first region 46. The pair of conductive plates 38 sandwich the spacer 40 in the stacking direction. One of the conductive plates 38 is in contact with the cathode 34c of the first membrane electrode assembly 341, and the other conductive plate 38 is in contact with the cathode 34c of the second membrane electrode assembly 342. The conductive plates 38 are made of a porous conductive material. Hydrogen generated at the cathodes 34c of the first membrane electrode assembly 341 and the second membrane electrode assembly 342 permeates the conductive plates 38. The conductive plates 38 form part of power supply paths for supplying electrical current to the cathodes 34c.

The spacer 40 is positioned between the pair of conductive plates 38. The spacer 40 is formed of a metal plate having conductivity and appropriate elasticity, such as stainless steel. The spacer 40 electrically connects the pair of cathodes 34c facing each other in the first region 46 via the conductive plates 38. The spacer 40 has a flat portion 40a and a plurality of leaf springs 40b protruding from the flat portion 40a in the stacking direction. The flat portion 40a abuts on one of the conductive plates 38, and the leaf springs 40b abut on the other conductive plate 38, thereby separating the pair of conductive plates 38 from each other.

The spacer 40 forms a common flow path 50 shared by the cathodes, through which hydrogen gas can flow between the pair of conductive plates 38. The common flow path 50 is a flow path shared by the cathode 34c of the first membrane electrode assembly 341 and the cathode 34c of the second membrane electrode assembly 342 adjacent to each other in the stacking direction. The common flow path 50 shared by the cathodes 34c collects the hydrogen gas generated in the pair of cathodes 34c and let the hydrogen gas flow toward the first passages 26, 28 (FIG. 2).

The packing 42 and the pressure-resistant body 44 are disposed in the periphery 35B of the first region 46. The packing 42 is positioned inside the pressure-resistant body 44 and is formed in a circular ring shape surrounding the reaction zone 35A. The packing 42 is formed of an elastic material such as rubber. The packing 42 is in close contact with the resin frame 34d of the first membrane electrode assembly 341 and the resin frame 34d of the second membrane electrode assembly 342, and seals the common flow path 50 shared by the cathodes 34c.

The pressure-resistant body 44 is formed in a circular ring shape. The inner diameter of the pressure-resistant body 44 is larger than the outer diameter of the packing 42. The pressure-resistant body 44 has strength that does not deform due to the internal pressure of the common flow path 50 shared by the cathodes 34c. The pressure-resistant body 44 surrounds the packing 42, prevents the packing 42 from expanding, and maintains the sealability of the packing 42.

In the second region 48, the first support plate 361 belonging to one unit structure 22 and the second support plate 362 belonging to another unit structure 22 are disposed. In the second region 48, the first support plate 361 and the second support plate 362 are joined to each other by a method such as diffusion bonding to form an integrated support plate 36. The support plate 36 receives the deformation force of the membrane electrode assembly 34 caused by the pressure difference between the first region 46 and the second region 48. The support plate 36 forms a common flow path 52 shared by the anodes 34b and configured to allow hydrogen gas to flow through the second region 48.

The first support plate 361 and the second support plate 362 are components having the same shape. The first support plate 361 has an outer surface 36a facing the membrane electrode assembly 34 on the second direction side. The second support plate 362 has an outer surface 36a facing the membrane electrode assembly 34 on the first direction side. That is, the first support plate 361 and the second support plate 362 are oriented oppositely in the stacking direction. On the inner side of the stacked unit structures 22, the first support plate 361 and the second support plate 362 are joined to each other to form the integrated support plate 36.

The first support plate 361 and the second support plate 362 have open grooves 52a on the outer surfaces 36a. The open grooves 52a are arranged to face the reaction zone 35A of the membrane electrode assemblies 34. The open grooves 52a extend in the third direction. The open grooves 52a opens toward the membrane electrode assemblies 34. The open grooves 52a form part of the common flow path 52 shared by the anodes 34b and allow the first membrane electrode assembly 341 and the second membrane electrode assembly 342 to be supplied with low-pressure hydrogen gas.

Further, the first support plate 361 has a closed groove 52b and coolant grooves 54a on an inner surface 36b facing the second support plate 362. The closed groove 52b is positioned outside the reaction zone 35A of the membrane electrode assemblies 34. That is, the closed groove 52b is positioned in the periphery 35B. The closed groove 52b forms a flow path closed in the stacking direction when the first support plate 361 and the second support plate 362 are joined together. The closed groove 52b is in communication with the open groove 52a on the outer surface 36a via the through hole 52c. The common flow path 52 shared by the anode 34b is formed by the closed groove 52b, the through hole 52c, and the open groove 52a. One end of the common flow path 52 shared by the anode 34b in the third direction is in communication with the fourth passage 32a, and the other end in the third direction is in communication with the fifth passage 32b. The common flow path 52 is shared by two anodes of the membrane electrode assemblies 34 adjacent to the support plate 36, and allows hydrogen gas to flow therethrough.

The coolant grooves 54a extend in the fourth direction perpendicular to the plane on which FIG. 3 is drawn. When the first support plate 361 and the second support plate 362 are joined together, the coolant grooves 54a are closed in the stacking direction and form the coolant flow field 54 extending in the fourth direction. The coolant such as water flows through the coolant flow field 54. The coolant flowing through the coolant flow field 54 cools the membrane electrode assemblies 34 heated by the electrochemical reactions.

The pair of anodes 34b sandwiching the second region 48 are electrically insulated from each other. In order to prevent the anodes 34b from being electrically connected, at least a part of the support plate 36 is preferably made of an insulating material.

The end separator 56 is attached to each of the first support plate 361 positioned at the end in the first direction and the second support plate 362 positioned at the end in the second direction. The end separators 56 cover the inner surface 36b of the first support plate 361 and the inner surface 36b of the second support plate 362, respectively. The end separators 56 close the closed grooves 52b and the coolant grooves 54a in the stacking direction.

In the electrochemical module 12, the cathodes 34c of the pair of membrane electrode assemblies 34 sandwiching the first region 46 are electrically connected to each other. The anodes 34b of the pair of membrane electrode assemblies 34 sandwiching the first region 46 are electrically connected to each other. That is, the anodes 34b belonging to one unit structure 22 are electrically connected to each other, and the cathodes 34c belonging to one unit structure 22 are electrically connected to each other via the spacer 40. In this case, as shown in the drawings, a power supply 58 may supply drive current in parallel to the anodes 34b and the cathodes 34c of the respective unit structures 22.

In the electrochemical module 12, a plurality of unit structures 22 may be connected in series. In this case, for example, the anode 34b of one unit structure 22 on the first direction side is electrically connected to the cathode 34c of another adjacent unit structure 22 on the second direction side. By connecting all the unit structures 22 in this way, the series connection of the plurality of unit structures 22 is realized.

The electrochemical module 12 according to the present embodiment is configured in the manner described above. The electrochemical module 12 operates as follows.

Low-pressure hydrogen gas is supplied through the hydrogen supply and discharge unit 32 to the common flow path 52 which is shared by the anodes 34b in the support plate 36 of the electrochemical module 12. The hydrogen gas is then supplied to the anodes 34b of the membrane electrode assemblies 34.

The membrane electrode assembly 34 electrochemically moves the hydrogen gas to the common flow path 50 shared by the cathodes 34c on the high-pressure side. The hydrogen gas is moved via the membrane electrode assembly 34 against the difference in pressures. As a result, the pressure of the hydrogen gas is increased. The hydrogen gas generated in the two membrane electrode assemblies 34 is introduced into the first passages 26, 28 through one common flow path 50 shared by the cathodes 34c. In this way, the electrochemical module 12 increases the pressure of the hydrogen gas.

The electrochemical module 12 of the present embodiment described above includes the common flow path 50 shared by the cathode 34c of the first membrane electrode assembly 341 and the cathode 34c of the second membrane electrode assembly 342 in the first region 46 where the pair of cathodes 34c face each other. Therefore, the electrochemical module 12 can reduce the number of separators and the size in the stacking direction, compared to a conventional device in which a pair of separators are disposed for each membrane electrode assembly 34.

### First Modification

In the above description, the hydrogen pump 10 is exemplified as the electrochemical module 12, but the present embodiment is not limited thereto. The electrochemical module 12 can be used in a water electrolysis device. In this case, the electrochemical module 12 electrolyzes water supplied from the common flow path 52, generates hydrogen gas in the common flow path 50, and generates oxygen gas in the common flow path 52.

### Second Modification

The electrochemical module 12 can constitute a water electrolysis device by using as the electrolyte membrane 34a an anion conductive membrane through which OH⁻ ions are transported. In this case, the positions of the anode 34b and the cathode 34c of the membrane electrode assembly 34 shown in FIG. 3 are swapped. The support plate 36 is disposed in the first region 46, and the conductive plate 38 and the spacer 40 are disposed in the second region 48. The common flow path 52 in the second region 48 is in communication with the first passages 26 and 28. The common flow path 50 in the first region 46 is in communication with the fourth passage 32a and the fifth passage 32b. In this case, water is supplied to the electrochemical module 12 from the common flow path 50. The electrochemical module 12 outputs hydrogen from the common flow path 50 and outputs high-pressure oxygen gas from the common flow path 52.

With respect to the above disclosure, the following Appendices are disclosed.

### Appendix 1

An aspect of the disclosure is the electrochemical module 12 including the plurality of membrane electrode assemblies 34 stacked one another, the membrane electrode assemblies including the electrolyte membranes 34a, and the anodes 34b and the cathodes 34c sandwiching the electrolyte membranes, wherein the plurality of membrane electrode assemblies are stacked in a manner that the first region 46 where the anodes face each other and the second region 48 where the cathodes face each other appear alternately in a stacking direction, and at least one of the first region and the second region includes the common flow path 50, 52 shared by two adjacent membrane electrode assemblies. The electrochemical module can be reduced in size in the stacking direction because no separator is requited to be disposed in the common flow path.

### Appendix 2

In the electrochemical module according to Appendix 1, each of the first region and the second region is provided with the common flow path. By utilizing more common flow paths, the electrochemical module can further reduce the size in the stacking direction.

### Appendix 3

In the electrochemical module according to Appendix 2, the common flow path provided in either one of the first region and the second region may be configured to allow the fluid having pressure increased by one pair of adjacent membrane electrode assemblies to flow therethrough. The electrochemical module can reduce the size in the stacking direction by eliminating the need for thick separators that can withstand high pressure.

### Appendix 4

The electrochemical module according to Appendix 3, may further include the spacer 40 disposed in the common flow path through which the fluid having increased pressure flows, wherein the one pair of adjacent membrane electrode assemblies are separated by the spacer. The electrochemical module can prevent the common flow path formed in the first region from being closed.

### Appendix 5

In the electrochemical module according to Appendix 4, the spacer may be configured to electrically connect electrodes of the one pair of adjacent membrane electrode assemblies to each other. The electrochemical module can simplify the wiring structure.

### Appendix 6

The electrochemical module according to any one of Appendixes 3 to 5, may further include the support plate 36 that is disposed in the common flow path provided in the other one of the first region and the second region and configured to allow a fluid having pressure lower than the fluid having increased pressure to flow, the support plate being configured to allow the fluid having lower pressure to be supplied to another pair of adjacent membrane electrode assemblies. The electrochemical module can prevent the common flow path on the low-pressure side from being closed by the pressure difference.

### Appendix 7

In the electrochemical module according to Appendix 6, the support plate may have the coolant flow field 54 through which the coolant flows to cool the other pair of adjacent membrane electrode assemblies. The electrochemical module can further be reduced in size in the stacking direction because two membrane electrode assemblies can be cooled by the coolant flowing through one support plate.

### Appendix 8

In the electrochemical module according to Appendix 6 or 7, the support plate may prevent electrical conduction between electrodes of the other pair of adjacent membrane electrode assemblies. In the electrochemical module, because respective unit structures are electrically insulated, a plurality of unit structures can be connected in series.

It should be noted that the present invention is not limited to the disclosure described above, and various additional or alternative configurations could be adopted therein without departing from the essence and gist of the present invention.

1. An electrochemical module comprising:
a plurality of membrane electrode assemblies stacked one another, the membrane electrode assemblies comprising electrolyte membranes, and anodes and cathodes sandwiching the electrolyte membranes, wherein
the plurality of membrane electrode assemblies are stacked in a manner that a first region where the anodes face each other and a second region where the cathodes face each other appear alternately in a stacking direction, and
at least one of the first region and the second region includes a common flow path shared by two adjacent membrane electrode assemblies.

2. The electrochemical module according to claim 1, wherein each of the first region and the second region is provided with the common flow path.

3. The electrochemical module according to claim 2, wherein the common flow path provided in either one of the first region and the second region is configured to allow a fluid having pressure that is increased by one pair of adjacent membrane electrode assemblies to flow therethrough.

4. The electrochemical module according to claim 3, further comprising:
a spacer disposed in the common flow path through which the fluid having increased pressure flows, wherein the one pair of adjacent membrane electrode assemblies are separated by the spacer.

5. The electrochemical module according to claim 4, wherein the spacer is configured to electrically connect electrodes of the one pair of adjacent membrane electrode assemblies to each other.

6. The electrochemical module according to claim 3, further comprising:
a support plate that is disposed in the common flow path provided in the other one of the first region and the second region and configured to allow a fluid having pressure lower than the fluid having increased pressure to flow, the support plate being configured to allow the fluid having lower pressure to be supplied to another pair of adjacent membrane electrode assemblies.

7. The electrochemical module according to claim 6, wherein the support plate has a coolant flow field through which a coolant flows to cool the another pair of adjacent membrane electrode assemblies.

8. The electrochemical module according to claim 6, wherein the support plate prevents electrical conduction between electrodes of the another pair of adjacent membrane electrode assemblies.
